(19) United States
(12) Patent Application Publication
(10) Pub. No.: US 2026/0286463 A1
(43) Pub. Date: Sep. 24, 2026

(54) Hydrometallurgical Process for Recovering Palladium from a Spent Catalyst

(71) Applicants: Solvay SA, Bruxelles (BE); PEROXIDOS DO BRASIL LTDA, Curitiba (BR)

(72) Inventors: Leonardo Titericz, Curitiba (BR); Patrick Markus Dhaese, Curitiba (BR); Arnaud Lemaire, Brussels (BE); Rafael Petruy, Curitiba (BR)

(21) Appl. No.: 18/998,196

(22) PCT Filed: Jul. 25, 2023
(86) PCT No.: PCT/EP2023/070520

§ 371 Date: Jan. 24, 2025

(30) Foreign Application Priority Data
Jul. 26, 2022 (EP) 22187068.6

(51) Int. Cl. C22B 11/00; B01J 23/44; C22B 1/02; C22B 7/00

(52) U.S. Cl. CPC C22B 11/048; B01J 23/44; C22B 1/02; C22B 7/007

(57) ABSTRACT

The present invention relates to anew hydrometallurgical process for recovering palladium from a spent catalyst, wherein a specific order of multiple process-steps is carried out.

### CROSS-REFERENCE TO RELATED APPLICATIONS

This application is the United States national phase of International Patent Application No. PCT/EP2023/070520 filed Jul. 25, 2023, and claims priority to European Patent Application No. 22187068.6 filed Jul. 26, 2022, the disclosures of which are hereby incorporated by reference in their entireties.

### BACKGROUND OF THE INVENTION

### Field of the Invention

The present invention relates to a new hydrometallurgical process for recovering palladium from a spent catalyst.

### Description of Related Art

Palladium (Pd) and its complexes is used in many industrial applications. One important example is the use of palladium in catalysts, in particular in carrier supported catalysts, e.g. automobile exhaust catalysts, pharmaceutical catalysts or hydrogenation catalysts. Due to its low natural abundance, there is the need to recover and refine palladium from different containing spent materials. A critical issue of the recovery procedure is its efficiency regarding complete separation of the palladium from its support (carrier). Several palladium recovery processes are known in the prior art. These methods can be divided into two main categories: Pyrometallurgy and hydrometallurgy processes.

In pyrometallurgy processes, the spent catalyst is smelt and enriched at high temperature and the palladium is recovered by traditional methods. This type of recovery processes is used commonly in large scale up processes and has to be carried out by specialized companies. The process is characterized by high energy consumption and thus high CO₂ emissions. Furthermore, a high investment cost is related with the design of such a plant. That is why typically the source streams of many types of catalysts are combined into one smelter and this application is not dedicated for one particular catalyst (see Dong, H., et al.; International Journal of Mineral Processing; 2015; 145; p. 108-113).

On the other hand, hydrometallurgy recovery is less convenient to treat a mix of different catalysts, but when one specific catalyst needs to be recycled, it is more efficient than pyrometallurgy processes.

The hydrometallurgy recovery process can be divided into two sub-types: a carrier dissolution process and a palladium dissolution process.

In the first type of hydrometallurgy processes, the support is dissolved with a non-oxidizing acid or base where palladium is not dissolved and remained as sludge; see for example CN 1063667595 A. However, this process requires large amounts of reagents and thus is not suitable for large scale up recovery processes.

In the second type of hydrometallurgy recovery processes, palladium is extracted from the support/carrier by an acidic solution of an oxidant, leaving the support. However, often the carrier will be dissolved partially with the palladium and thus interferes with it. Hence, the palladium cannot be completely separated from the carrier. A further problem is that the carrier of the spent catalyst includes usually inorganic and/or organic impurities. Their presence during the recovery process also results into a reduction of the palladium recovery rate, as for example described in CN 104032143 A. Moreover, in hydrometallurgy recovery processes as described in the prior art, for example in CN 101186971 A, CN 104032143 A or CN 111321307, the dissolved palladium, i.e., the palladium separated from the carrier, cannot be obtained by a simple purification step, but several purification steps are necessary to obtain palladium in a form that can be further used. Theses purification steps bears an additional risk of reduction of the palladium recovery rate.

Therefore, there was still the need to provide a palladium recovery process, which is simple, cost-efficient, has a high palladium recovery rate, can be used in large scale up processes, and ensures that no specialized companies are needed to carry out the process.

### SUMMARY OF THE INVENTION

The present invention relates to a process for recycling palladium from a spent catalyst containing palladium deposited on a carrier, comprising the following consecutive steps:
(a) calcination of the spent catalyst to obtain a calcined catalyst;
(b) reduction of the calcined catalyst with reducing agent to obtain a reduced catalyst slurry;
(c) leaching the reduced catalyst slurry with a leaching medium by forming a leaching mixture and afterwards filtration of the leaching mixture to obtain a liquor containing palladium;
(d) treatment of the liquor with a reducing agent and an alkali metal hydroxide to obtain a treated liquor;
(e) filtration of the treated liquor to recover a palladium sponge; and
(f) optional treatment of the palladium sponge with hydrochloric acid and hydrogen peroxide to a solution of palladium.

The process of the invention has a palladium recovery rate of at least 99.5%. The process is simple and can be done on-site. Furthermore, the process is cost-efficient and allows that the recovered palladium can be directly used in the production of a fresh catalyst.

### DESCRIPTION OF THE INVENTION

Before the present process of the invention and used thereof is described, it is to be understood that this invention is not limited to specific process conditions described, since such conditions may, of course, vary. It is also to be understood that the terminology used herein is not intended to be limiting, since the scope of the present invention will be limited only by the appended claims.

As used herein, the singular forms “a”, “an”, and “the” include both singular and plural referents unless the context clearly dictates otherwise. By way of example, “a compound” means one compound or more than one compound.

The terms “containing”, “contains” and “contained of” as used herein are synonymous with “including”, “includes” or “comprising”, “comprises”, and are inclusive or open-ended and do not exclude additional, non-recited members, elements or process steps. It will be appreciated that the terms “containing”, “contains”, “comprising”, “comprises” and “comprised of” as used herein comprise the terms “consisting of”, “consists” and “consists of”.

Throughout this application, the term “about” is used to indicate that a value includes the standard deviation of error for the device or method being employed to determine the value.

As used herein, the term “average” refers to number average unless indicated otherwise.

As used herein, the terms “% by weight”, “wt.-%”, “weight percentage”, or “percentage by weight” are used interchangeably. The same applies to the terms “% by volume”, “vol.-%”, “vol. percentage”, or “percentage by volume”, or “% by mol”, “mol-%”, “mol percentage”, or “percentage by mol”.

The recitation of numerical ranges by endpoints includes all integer numbers and, where appropriate, fractions subsumed within that range (e.g. 1 to 5 can include 1, 2, 3, 4 when referring to, for example, a number of elements, and can also include 1.5, 2, 2.75 and 3.80, when referring to, for example, measurements). The recitation of end points also includes the end point values themselves (e.g. from 1.0 to 5.0 includes both 1.0 and 5.0). Any numerical range recited herein is intended to include all sub-ranges subsumed therein.

All references cited in the present specification are hereby incorporated by reference in their entirety. In particular, the teachings of all references herein specifically referred to are incorporated by reference.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

The terms “carrier” and “support” as used herein are synonymously to each other.

In the following passages, different alternatives, embodiments and variants of the invention are defined in more detail. Each alternative and embodiment so defined may be combined with any other alternative and embodiment, and this for each variant unless clearly indicated to the contrary or clearly incompatible when the value range of a same parameter is disjoined. In particular, any feature indicated as being preferred or advantageous may be combined with any other feature or features indicated as being preferred or advantageous.

Furthermore, the particular features, structures or characteristics described in present description may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and from different embodiments, as would be understood by those in the art.

In order to overcome the disadvantages of the processes known in the prior art, the present application provides a recovery process for palladium from a spent catalyst characterized by the following combination of consecutive process steps:
(a) calcination of the spent catalyst to obtain a calcined catalyst;
(b) reduction of the calcined catalyst with reducing agent to obtain a reduced catalyst slurry;
(c) leaching the reduced catalyst slurry with a leaching medium by forming a leaching mixture and afterwards filtration of the leaching mixture to obtain a liquor containing dissolved palladium;
(d) treatment of the liquor with a reducing agent and an alkali metal hydroxide to obtain a treated liquor;
(e) filtration of the treated liquor to recover a palladium sponge; and
(f) optional treatment of the palladium sponge with hydrochloric acid and hydrogen peroxide to a solution of palladium.

The spent catalyst treated by the process according to the invention can be any type of spent catalyst that comprises palladium. According to the invention, it is preferred that the catalyst is a slurry catalyst comprising palladium. In particular it is preferred that the catalyst is a hydrogenation catalyst used for the production of hydrogen peroxide, in particular used in an Anthraquinone-Auto-Oxidation-process (AO-process) for the production of hydrogen peroxide.

The support/carrier of the catalyst can be any suitable support known in the prior art. Preferably, the carrier is selected from the group consisting of carbon, silica, alumina, alumino-silicate, zirconia, zircon-silicate, and magnesium aluminate, more preferably the carrier is selected from the group consisting of silica, alumina, alumino-silicate, zirconia, zircon-silicate, and magnesium aluminate, and even more preferred the carrier is an alumina or an alumino-silicate support.

It is state of the art that the carrier of a spent catalyst includes inorganic and/or organic impurities, which influence the efficiency of the metal (palladium) recovery process. For example, the carrier of a catalyst used an AO-process includes significant amounts of organic impurities. The presence of the impurities may result into undesired by-products during the recovery process. Therefore, it is preferred to remove the impurities from the carrier at the beginning of the recovery process. One possibility seems to be to calcine the spent catalyst. However, as for example mentioned in the scientific publication of Barakat et al., Applied Catalysis A, General 301 (2006), pages 182-186, such a heat treatment of the supported catalyst results into an undesired low recovery rate of palladium, because during the calcination there is the high risk that the palladium will be trapped in the carrier. This is particular the case when the carrier is an alumina or an alumina-silicate support, and thus it is not possible to separate the palladium from the carrier in a sufficient manner.

However, the inventors of the present application surprisingly found that by using the multiple step procedure of the invention, a previously calcination of the spent catalyst to remove the impurities increases the amount of recovered palladium.

The calcination should be carried out at a temperature, which is high enough to remove the impurities, in particular the organic impurities, from the carrier. However, it has been found by the inventors that above a certain temperature a further increase of the temperature has no influence on the effectivity of the calcination. Therefore, according to the invention, a calcination temperature from 450° to 650° C. is preferred, more preferred is a temperature from 500 to 600° C., more preferred is a temperature from 510 to 560° C. and most preferred is a temperature from 520 to 530° C.

Furthermore, the calcination should be carried out for a duration sufficient to remove the impurities from the carrier. Preferably, the calcination is carried out for at least 60 minutes, more preferably for at least 90 minutes, at least 120 minutes or at least 180 minutes. A duration of 270 minutes or less, for example of 260 minutes, 250 minutes or 240 minutes may be sufficient to complete the calcination step. In particular preferred is a duration of from 230 to 270 minutes, more preferably from 240 to 260 minutes.

Furthermore, if necessary, according to the invention, the catalyst may be grinded before calcination by grinding method usually used in the prior art.

In a preferred embodiment, after calcination of the spent catalyst, the calcined catalyst is cooled, preferably cooled down to room temperature (approx. 20 to 25° C.), and afterwards water, more preferably demineralized water (DMW), is added to the calcined catalyst.

In process step (b) of the invention, a reducing agent is added to the calcined catalyst. Preferably, the reducing agent is added to the calcined catalyst after water, preferably DMW was added to the calcined catalyst.

The reducing agent is selected preferably from the group consisting of formic acid, sodium formate, sodium hypophosphite, sodium borohydrade, hydrogen gas, formaldehyde and mixtures thereof, preferably the reducing agent is formic acid.

If the reducing agent is formic acid an aqueous solution of formic acid preferably is used. This solution has preferably a formic acid concentration of 60 to 95%, more preferably of 70 to 90%, most preferably of 75 to 85%.

Additionally, it is preferred that the reduction step (b) is carried out with a liquid to solid (L/S) ratio of 2 to 7, more preferred with a L/S ratio of 3 to 5.

Furthermore, according to the invention, the ratio of reducing agent to calcined catalyst is preferably between 1:8 and 1:20, more preferably between 1:9 and 1:15.

Moreover, the reduction step (b) of the invention is carried out preferably at a temperature between 5° and 80° C., more preferably between 55 and 70° C., most preferably between 6° and 65° C.

The duration time of reduction step (b) is preferably at least 30 minutes. More preferred is that the reduction step is carried out for at least 45 minutes. 60 minutes may be sufficient to reduce the palladium oxide present in the calcined catalyst to palladium.

The reduction step (b) of the process according to the claimed invention results into a reduced slurry of the catalyst.

Afterwards, according to the invention, the obtained reduced catalyst slurry is leached to separate the palladium from the carrier. This is done by dissolving the palladium with the aid of a leaching medium.

For leaching the reduced slurry obtained in step (b) inorganic acids in combination with oxidants may be used. For example, the inorganic acid can be hydrochloric acid or sulfuric acid and the oxidants can be hypochlorite, hydrogen peroxide, sodium chlorate or nitric acid or mixtures thereof.

The conditions of the leaching step have to be chosen such that the dissolution of the carrier into the leaching mixture is reduced or even avoided. According to the invention, it is preferred to use hydrochloric acid in combination with hydrogen peroxide as a leaching medium, more preferably to use an aqueous solution of hydrochloric acid in combination with an aqueous solution of hydrogen peroxide as leaching medium. According to the invention, the addition of the leaching medium to the reduced catalyst slurry can be carried out such that a leaching medium comprising/consisting of simultaneously hydrochloric acid and hydrogen peroxide, preferably in form of aqueous solutions, is added to the reduced catalyst slurry or an aqueous solution of hydrochloric acid and an aqueous solution of hydrogen peroxide are added separately from each other to the reduced catalyst slurry. In both cases a leaching mixture is formed comprising/consisting of the reduced catalyst slurry and the leaching medium.

The palladium can be dissolved with the help of hydrogen peroxide as oxidizing agent in the presence of the acid medium (hydrochloric acid) by the following chemical equitation:

$$Pd + {H}_{2} {O}_{2} + 4 HCl = {H}_{2} {PdCl}_{4} + {H}_{2} O .$$

The palladium forms stable chloro-complexes such PdCl⁺, PdCl₂, PdCl₃⁻ and PdCl₄²⁻ in the hydrochloric acid solution. The formation of these complexes in solution enhances the dissolution of palladium from the carrier material.

According to the invention, it is preferred that the hydrochloric acid is used in form of an aqueous solution having a hydrochloric acid concentration of 30 to 45%, more preferably of 33 to 37%. The solution is added preferably to the reduced catalyst slurry at a temperature preferably from 55 to 100° C., more preferably from 60 to 98° C., most preferably from 65 to 95° C.

Additionally, it is preferred that the hydrogen peroxide is used in form of aqueous solution, which has a hydrogen peroxide concentration of 55 to 65%, preferably of 60%. The solution is added preferably with a constant flow to the system of reduced catalyst slurry and hydrochloric acid to obtain the leaching mixture.

It is further preferred that the weight ratio of hydrogen peroxide to hydrochloric acid is between 1:1.5 and 1:2.5, more preferably, between 1:1.7 and 1:2.2.

It is preferred that the leaching step is carried out for at least 60 minutes, more preferably for at least 90 minutes. Preferably, the leaching step is carried out for 60 to 120 minutes, preferably for 90 to 100 minutes.

Furthermore, it is preferred that the leaching step is carried out with a liquid to solid ratio (L/S ratio) from 4:1 to 15:1, more preferably from 5:1 to 10:1 most preferably with L/S ratio of 5:1.

Additionally, it is preferred that the leaching mixture is continuously stirred, for example at a stirring speed of 60 to 100 rpm or of 80 to 90 rpm.

Subsequently, preferably when the room temperature is reached, the leaching mixture is filtrated to obtain a liquor containing the dissolved palladium. Furthermore, it is preferred that after filtration of the leaching mixture, the precipitated carrier is washed with demineralized water and the used washing solution is combined with the filtrate to obtain the liquor containing the dissolved palladium.

In order to separate the dissolved palladium from the liquor obtained in process step (c) of the invention, it is sufficient to use a reducing agent, which is suitable to reduce Pd²⁺, to Pd⁰, in combination with an alkali metal hydroxide, preferably in combination with sodium hydroxide or potassium hydroxide, even more preferred in combination with the sodium hydroxide.

The reducing agent is selected preferably from the group consisting of formic acid, sodium formate, zinc, iron, aluminium, sodium hypophosphite, sodium borohydrade, hydrogen gas and formaldehyde, preferably the reducing agent is formic acid and/or sodium formate. Most preferably, the reducing agent is the same reducing agent as used in process step (b) of the invention. If the reducing agent is formic acid, an aqueous solution of formic acid is used in the process of the invention having preferably a formic acid concentration of 60 to 95%, more preferably of 70 to 90%, most preferably of 75 to 85%.

Furthermore, according to the invention, it is preferred that the alkali metal hydroxide, preferably sodium hydroxide, is used in form of an aqueous solution having an alkali metal hydroxide concentration preferably of 40 to 60%, more preferably of 45 to 55%.

In one embodiment of the invention, it is preferred that the reducing agent is used in an amount of 1.5 to 3.5 wt.-%, more preferably of 2 to 3 wt.-%, and the alkali metal hydroxide, preferably sodium hydroxide, in an amount of 2.0 and 3.5 wt.-%, more preferably of 2.5 to 3.0 wt.-%, based on the total weight of the liquor treated in step (d).

The reduction step (d) of the process according to the invention is preferably carried out at a temperature of 75 to 120° C., more preferably of 80 to 110° C., most preferably at a temperature of 85 to 100° C. The duration time of this process step is preferably between 100 and 300 minutes, more preferably between 120 and 250 minutes. Additionally, it is preferred to stir the mixture at a speed of 50 to 80 rpm, more preferably of 55 to 75 rpm.

The reduced palladium is obtained in form of a sponge by filtration.

The obtained palladium sponge can be optionally further treated with hydrochloric acid and hydrogen peroxide to obtain a solution of palladium.

According to the invention, it is preferred that the hydrochloric acid is used in form of an aqueous solution having a hydrochloric acid concentration of 30 to 45%, more preferably of 33 to 37%.

Additionally, it is preferred that the hydrogen peroxide is used in form of aqueous solution, which has preferably a hydrogen peroxide concentration of 55 to 65%, preferably of 60%.

Moreover, the weight ratio of hydrochloric acid to hydrogen peroxide is preferably between 1:1 and 1:1.5, more preferably between 1.1 and 1:1.2.

The re-dissolution step is preferably carried out at a temperature of 50 to 70° C., more preferably of 55 to 65° C. The duration time of this process step is preferably 90 to 150 minutes, more preferably of 100 to 120 minutes. Additionally, it is preferred to stir the mixture at a speed of 50 to 80 rpm, more preferably of 55 to 75 rpm.

After cooling, the solution can be directly used in different applications.

The process of the invention is simple and can be carried out in a lab, a middle scale or in a large scale mode.

By using the process of the invention, it is possible to recover at least 99.5%, at least 99.8%, or at least 99.9% of the palladium present in the spent catalyst.

The palladium recovered by the process of the invention or solution thereof can be for example directly used in the production of a fresh catalyst. In that case it is possible to provide a new catalyst in one week. Moreover, since the process of the invention is simple, there is no need to outsource the recovery process, and the process is cost-efficient.

The present invention is further illustrated by the following examples. It should be understood that the following examples are for illustration purposes only, and are not used to limit the present invention thereto.

### EXAMPLES

### Example 1

Example 1 was carried out to determine the optimal conditions, i.e. temperature and time, for calcination of a spent catalyst, in particular of a slurry catalyst.

### Procedure of Calcination

For all essays done, 10 g of the catalyst were weighted in lab scale on compatible crucible. In the meantime, the lab control oven (muffle furnace) was set with such temperature estimated previously.

When the temperature achieves the set point, the crucible was positioned in the middle of the furnace with the frontal door opened (during 10 minutes), and only after, with the door closed, the counting of the time starts. After the achievement of time expected, the sample was removed from the furnace and cooled down inside a desiccator during 30 minutes. The determination of best temperature and time where obtained by a central composite design study, based in the loss of mass of each test.

In Table 1 the results from Design of Experiments done for the slurry catalyst are summarized.

TABLE 1

| Parameters | | Mass |
|---|---|---|
| Temp. [° C.] | Time [min] | loss [%] |
| 350 | 120 | 47.1 |
| 350 | 360 | 47.0 |
| 550 | 120 | 52.4 |
| 550 | 360 | 52.4 |
| 450 | 240 | 52.2 |
| 450 | 240 | 52.0 |
| 450 | 240 | 52.0 |
| 450 | 60 | 52.1 |
| 450 | 420 | 52.3 |
| 300 | 240 | 45.0 |
| 600 | 240 | 52.5 |

A graphical counter plot of these data shows that the maximum mass loss (impurity loss) for the slurry catalyst is obtained at a temperature of 525° C. and a duration of 255 minutes.

### Example 2 (Invention)

In Example 2 the process of the invention was carried in lab scale mode. The catalyst was a sodium silico-aluminate catalyst, which was calcinated at a temperature of 550° C. and for a period of 240 minutes.

The conditions used in the process steps according to the invention were:

TABLE 2

| | | | | 3. Purification | | 4. Re-dissolution | |
|---|---|---|---|---|---|---|---|
| 1. Reduction Step | | 2. Leaching Step | | Step | | Step | |
| (process step (b)) | | (process step (c)) | | (process step (d)) | | (process step (f)) | |
| Calcined catalyst | | HCl 37% | | Formic acid 85% | | HCl 37% | |
| 100 | g | 186 | g | 120 | g | 17.5 | g |
| Formic acid 85% | | H₂O₂ 60% | | NaOH 50% | | H₂O₂ 60% | |
| 9.5 | mL | 84 | g | 60 | g | 17 | g |
| Demineralized | | | | | | | |
| Water (DMW) | | | | | | | |
| 258 | g | | | | | | |
| 65° | C. | 60° | C. | 100 ° | C. | 60° | C. |
| 30 | min | 120 | min | 120 | min | 120 | min |

The palladium recovery rate was 99.75%.

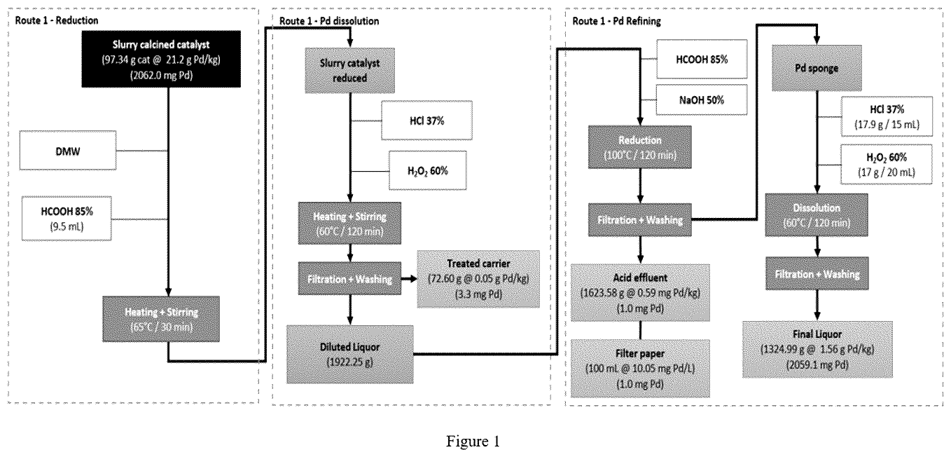

For a better understanding regarding the order of process steps, in FIG. 1 a flow chart of the steps used in Example 2 are shown.

### Example 3 (Invention)

In Example 3 the process of the invention was carried in a middle scale mode. The catalyst was a silico-aluminate catalyst, which was calcinated at a temperature of 550° C. and for a period of 240 minutes.

The conditions used in the process steps according to the invention were:

TABLE 3

| | | | | 3. Purification | | 4. Re-dissolution | |
|---|---|---|---|---|---|---|---|
| 1. Reduction Step | | 2. Leaching Step | | Step | | Step | |
| (process step (b)) | | (process step (c)) | | (process step (d)) | | (process step (f)) | |
| Calcined catalyst | | HCl 33% | | Formic acid 85%: | | HCl 37% | |
| 5 | kg | 10.4 | kg | 2.25 | kg | 0.5 | kg |
| Formic acid 85% | | H₂O₂ 60% | | NaOH 50% | | H₂O₂ 60% | |
| 475 | ml | 4.2 | kg | 3.50 | kg | 75 | ml |
| Demineralized | | | | | | | |
| Water (DMW) | | | | | | | |
| 13.7 | kg | | | | | | |
| 65° | C. | 95° | C. | 85° | C. | 60° | C. |
| 30 | min | 60 | min | 250 | min | 120 | min |

The palladium recovery rate was 99.89%.

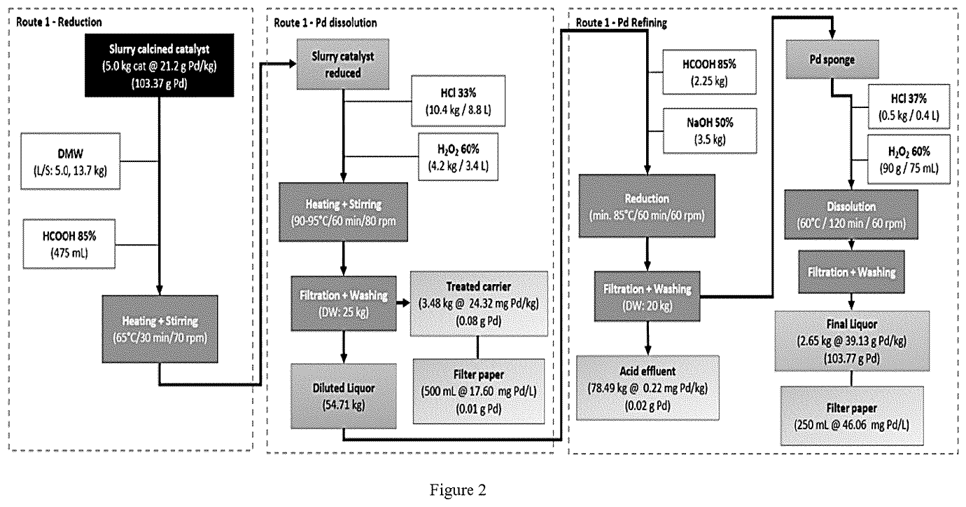

For a better understanding regarding the order of process steps, in FIG. 2 a flow chart of the steps used in Example 3 are shown.

### Example 4 (Comparative Example)

In Example 4 the process step (b) and (c) of the invention was carried with spent silico-aluminate catalyst, which was not calcined, i.e. process step (a) of the invention was not carried out.

The conditions used in the process steps (b) and (c) were:

TABLE 4

| 1. Reduction Step | | 2. Leaching Step | |
|---|---|---|---|
| (process step (b)) | | (process step (c)) | |
| Not-calcined | | HCl 37% | |
| catalyst | | 186 | g |
| 217.57 | g | | |
| Formic acid 85% | | H₂O₂ 60% | |
| 9.5 | ml | 84 | g |
| Demineralized | | | |
| Water (DMW) | | | |
| 258 | g | | |
| 65° | C. | 80° | C. |
| 30 | min | 60 | min |

It was not possible to separate the palladium dissolved in the leaching mixture from the carrier by filtration in a sufficient manner due to the clogging of the filter by the leaching mixture. Therefore, no further purification steps to recover the palladium were carried out.

Hence, without calcination of the catalyst it is not possible to recover the palladium in a sufficient amount.

1. A process for recycling palladium from a spent catalyst containing palladium deposited on a carrier, comprising the following consecutive steps:
(a) calcination of the spent catalyst to obtain a calcined catalyst;
(b) reduction of the calcined catalyst with a reducing agent to obtain a reduced catalyst slurry;
(c) leaching the reduced catalyst slurry with a leaching medium by forming a leaching mixture and afterwards filtration of the leaching mixture to obtain a liquor containing dissolved palladium;
(d) treatment of the liquor with a reducing agent and an alkali metal hydroxide to obtain a treated liquor;
(e) filtration of the treated liquor to recover a palladium sponge; and
(f) optional treatment of the palladium sponge with hydrochloric acid and hydrogen peroxide to obtain a solution of palladium.

2. The process according to claim 1, wherein the carrier of the catalyst is selected from the group consisting of carbon, silica, alumina, alumino-silicate, zirconia, zircon-silicate, and magnesium aluminate.

3. The process according to claim 1, wherein the calcination of the spent catalyst is carried out at a temperature of 450° C. to 650° C. for 60 to 270 minutes.

4. The process according to claim 1, wherein the reducing agent of step (b) and/or of (d) is selected independently from each other from the group consisting of formic acid, sodium hypophosphite, sodium borohydrade, hydrogen gas and formaldehyde and mixtures thereof, preferably the reducing agent of step (b) and/or of step (c) is formic acid.

5. The process according to claim 1, wherein the reduction step (b) is carried out at a temperature of 50 to 80° C. for 30 to 60 minutes.

6. The process according to claim 1, wherein the leaching medium comprises hydrochloric acid and hydrogen peroxide.

7. The process according to claim 6, wherein in step (c) the hydrochloric acid is added to the reduced catalyst slurry in form of an aqueous solution having a hydrochloric acid concentration of 30 to 45% and the hydrogen peroxide is added to the reduced catalyst slurry in form of aqueous solution having a hydrogen peroxide concentration of 55 to 65% to form the leaching mixture.

8. The process according to claim 1, wherein the step (c) is carried out with a liquid to solid ratio (L/S ratio) from 4:1 to 15:1.

9. The process according to claim 1, wherein the leaching of the reduced catalyst slurry in step (c) is carried out at a temperature between 55 and 100° C. for 60 to 120 minutes.

10. The process according to claim 1, wherein in step (d) an aqueous solution of sodium hydroxide having a sodium hydroxide concentration of 40 to 60% is used.

11. The process according to claim 1, wherein step (d) is carried out at a temperature of 75 to 120° C. for 100 to 300 minutes.

12. The process according to claim 1, wherein in the optional step (f) an aqueous solution of hydrochloric acid having a hydrochloric acid concentration of 30 to 45% and an aqueous solution of hydrogen peroxide having a hydrogen peroxide concentration of 55 to 65% is used.

13. The process according to claim 1, wherein optional step (f) is carried out at a temperature of 50 to 70° C. for 90 to 150 minutes.

14. The process according to claim 1, wherein the spent catalyst is a hydrogenation catalyst used in the production of hydrogen peroxide.

15. (canceled)

16. A method of preparing a catalyst, comprising, using palladium recovered by the method of claim 1 to prepare the catalyst.
